(19) United States
(12) Patent Application Publication
(10) Pub. No.: US 2003/0105645 A1
(43) Pub. Date: Jun. 5, 2003

(54) Magazine trading system

(76) Inventor: Jason S. Flegel, Naples, FL (US)

Correspondence Address: John S. Beulick, Armstrong Teasdale LLP, Suite 2600, One Metropolitan Sq., St. Louis, MO, 63102, US

(21) Appl. No.: 10/162,423

(22) Filed: Jun. 3, 2002

Related U.S. Application Data
(60) Provisional application No. 60/295,687, filed on Jun. 4, 2001.

(51) Int. Cl. G06F 17/60

(52) U.S. Cl. 705/1; 705/40

(57) ABSTRACT

A scan based system for trading bar coded magazines, the system having a distributor and a retailer, the distributor providing the retailer with at least one bar coded magazine wherein the retailer sells the magazine by scan based sales generating distributor acceptable scan based trading payment information.

A computer network-based system for electronically exchanging scan based magazine trading data between a central site and a plurality of remote users, the system comprising a central server; at least one database installed on the server, the database comprising data representing information related to retailer payment of at least one scan based magazine trade, said database comprising at least one of a product price, a UPC code, a bipad number, a goods availability, an issue and a product distributor; and at least one remote computer terminal having an input device for generating input data, and an output device, said remote terminal connected to said central server for transmitting data between said central server and said remote terminal.

This application claims the benefit of priority of U.S. Provisional Patent Application Serial No. 60/295,687, filed Jun. 4, 2001.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

This invention relates generally to a scan based magazine trading system and more particularly to a scan based magazine trading system based on scan based payment records collected from a retailer.

Electronic commerce deals with business entities providing business information to one another in a trading (buying/selling) process. Electronic data interchange (EDI) is used in electronic commerce and is an electronic business information interchange using a public format. (Electronic Commerce at the UCC, Version 1.0, May 12, 1999, http://www.uc-council.org). EDI is one of several methods of payments and transactions which can be used in magazine trading (buying/selling).

Magazines are published on daily, weekly, monthly, quarterly and annual basis called issues. Universal Product Code (UPC) bar codes are applied on magazines. A UPC code originates with the Uniform Code Council, Inc. (UCC) in that a publisher pays an annual fee to obtain UPC bar codes. UPC bar codes are assigned by the publisher to a magazine issue based on a price for a magazine issue. UPC bar codes facilitate trading communication between trading partners in the process of trading (buying/selling) magazines. Many bar coded magazines are sold in retail store checkout lines to consumers. The scanning of bar codes on magazines allows retail businesses to greatly speed up the process of magazine checkout since the sales checkout clerks are able to input data with more speed by scanning.

Presently suppliers deliver magazines to retail stores and also pickup “returns” from the store for unsold magazines. The invoice that is left with the store for the delivery by the supplier is made up of a billing for the magazines that were delivered as well as credits for the magazines that were picked up or “returned” to the supplier. The net invoice (shipment minus returns) is the amount that is due (from the shipment) by the seller to the supplier. Presently shrink is absorbed by the retailer. With the current magazine trading process, ‘a magazine lost or stolen is a magazine sold’ meaning that the retailer pays for all such lost or stolen magazines which means that the retailer absorbs shrink.

Although some checkout scanning systems have made the magazine checkout process more efficient, several problems remain. For example, most scanner checkout systems pick up only the regular twelve digit code of a typical UPC code and do not pick up the additional two digits of the UPC code on a magazine. The last two digits of this fourteen-digit UPC code are important to the magazine publisher since the last two digits identify the issue. The magazine publisher has a need to evaluate the sales effectiveness of a particular cover and so the publisher needs to correlate cover design to sales as well as issue specific sales for advertisement.

Magazine returns, rebates, missing magazines and unsold magazine issues need to be addressed in an accounting manner. There is a need to have a facile payment system in place for handing such as the above. It would be desirable to provide a system which eliminates a need for processing magazine returns, automates the rebate process, establishes factors for missing and unsold magazines and structures the magazine trading/transaction directly between the publisher/national distributor and a retailer.

### BRIEF SUMMARY OF THE INVENTION

These and other objects may be attained in one aspect by a scan based system for trading bar coded magazines whereby the system comprises an entity such as a distributor and another entity such as a retailer, with the distributor providing the retailer with at least one bar coded magazine. The retailer utilizes a scan based sales system in selling the magazine and in an aspect, generates a scan based trading payment record. In another aspect, payment by the retailer to the distributor is based on the retailer's scan based trading record.

In another embodiment, the system is a computer network-based system for electronically exchanging scan based magazine trading payment record data between a central site and a plurality of remote users with the system comprising a central server; at least one database installed on the server, the database comprising data representing information related to retailer payment of at least one scan based magazine trade, said database comprising at least one of a product price, a UPC code, a bipad number, a goods availability, an issue and a product distributor; and at least one remote computer terminal having an input device for generating input data, and an output device, said remote terminal connected to said central server for transmitting data between said central server and said remote terminal.

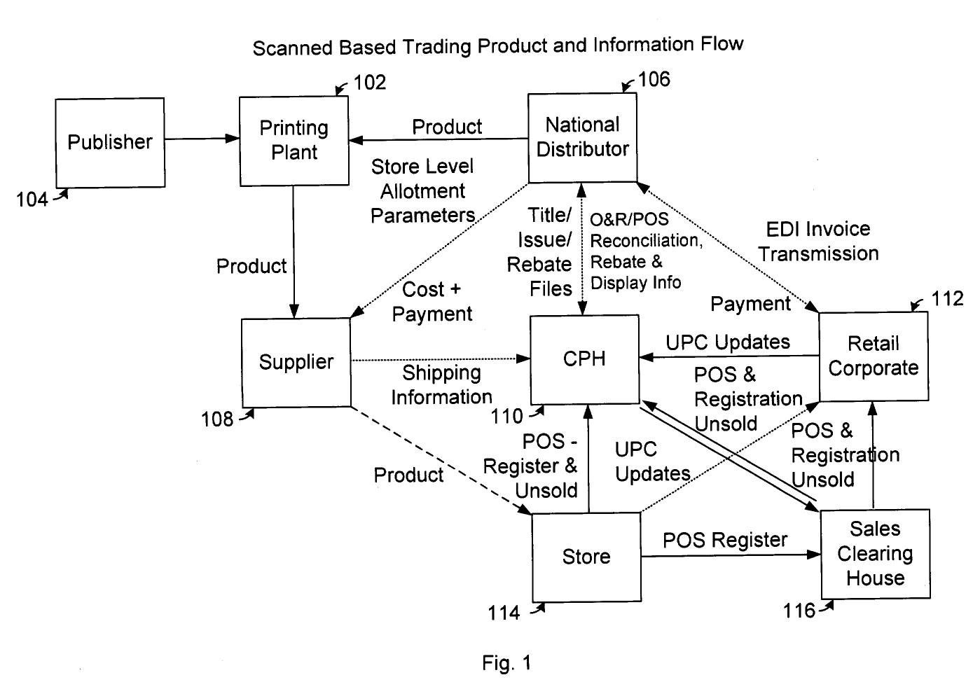

FIG. 1 is a block diagram of a scanned based magazine trading and information flow system.

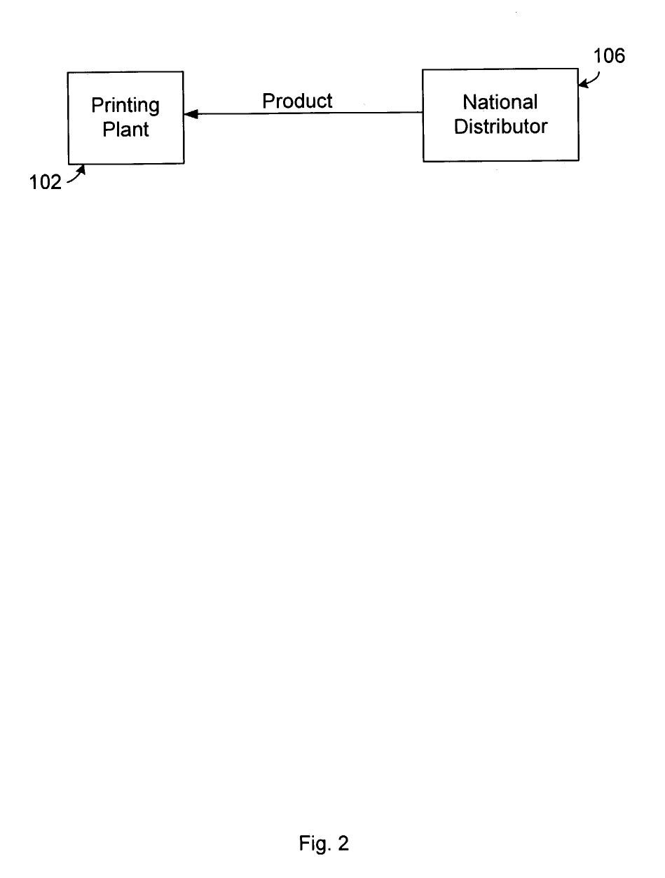

FIGS. 10, 12, 14, 16, 18, 20, 22, 24, 26, 30, 32, 34 and 36 are block diagrams of exemplary entities of an exemplary scanned based magazine trading and information flow system illustrated in FIG. 1.

### DETAILED DESCRIPTION OF THE INVENTION

More in particular, FIG. 1 is a flow chart of an exemplary system for a magazine scanned based trading showing several entities involved in the trading process. Exemplary invoicing and communication between illustrative entities of an exemplary system is illustrated more in detail in other Figures herein.

Printing Plant 2 symbolizes a facility printing a magazine.

Publisher 4 symbolizes an entity producing editorial content for a magazine

National Distributor 6 symbolizes a company distributing magazines for multiple magazine publishers. As used herein the term “distributor” includes national distributors.

Supplier 8 symbolizes an entity supplying magazines to individual stores by direct shipment via common carrier to a store or by delivering magazines with its fleet.

CPH (Central Processing Hub 10): entity collecting pertinent data including magazine shipment information, scanned sales data and title information for processing invoices for scanned based trading.

Retail Corporate 12 symbolizes a corporate headquarters for magazine data processing for a retailer.

Store 14 symbolizes a store location(s) where magazines could be sold through a scanning based sale system. Store 14 is a part of the corporate structure of retail corporate 12.

Sales Clearing House 16 symbolizes an entity that could collect scanned based sale magazine data on behalf of a retailer.

FIG. 10 shows an exemplary scan based magazine trading and information flow system between National Distributor 6 and Printing Plant 2. More particularly, National Distributor 6 determines a total number of copies to be printed for each magazine that the National Distributor represents. This number is termed a print order. The print order (not shown) is provided to Printing Plant 2 so that there will be an appropriate number of copies printed for distribution to Supplier 8.

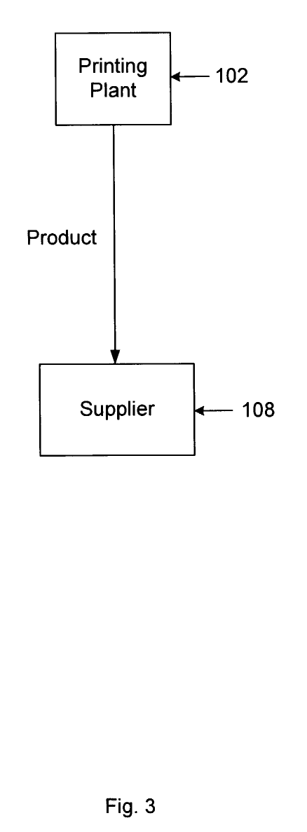

FIG. 12 shows an exemplary scan based magazine trading and information flow system between Printing Plant 2 and Supplier 8. Printing Plant 2 prints and transfers the appropriate number of each magazine to Supplier 8.

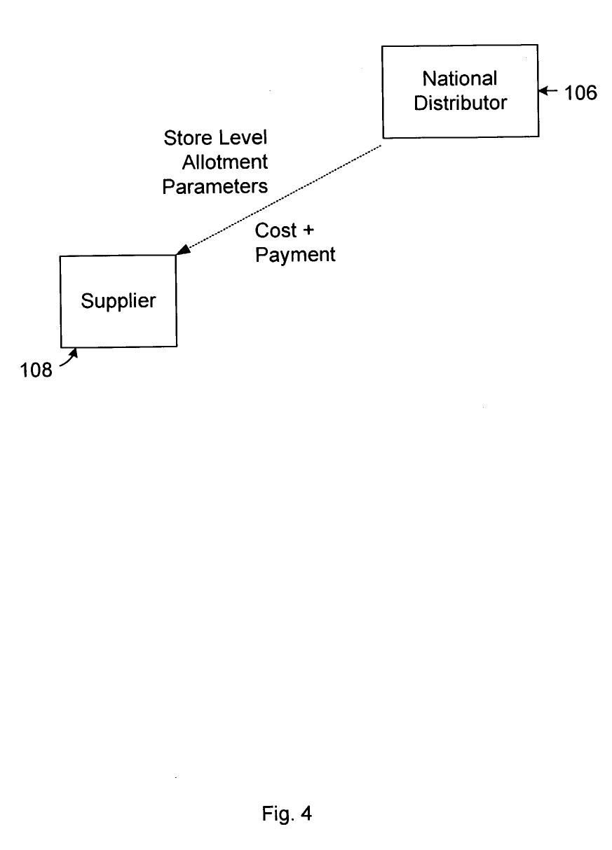

FIG. 14 shows an exemplary scan based magazine trading and information flow system between National Distributor 6 and Supplier 8. National Distributor 6 notifies Supplier 8 of the total number of each magazine that should be delivered to each Store 14 serviced by Supplier 8.

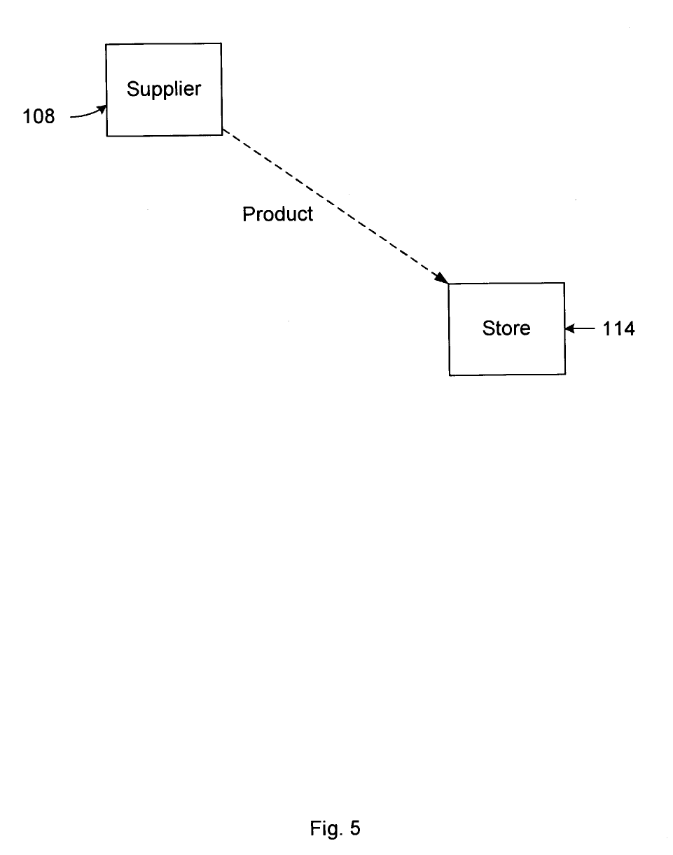

FIG. 16 shows an exemplary scan based magazine trading and information flow system between a Supplier 8 and a Store 14. The Supplier 8 is responsible for getting the appropriate number of magazines to each Store 14 serviced by that Supplier 8. The Supplier 8 can either ship product direct to the Store 14 via a shipping company (such as United Parcel Service or Federal Express) or the Supplier 8 can make the actual delivery (not shown) to the Store 14 using its own automobiles if desired.

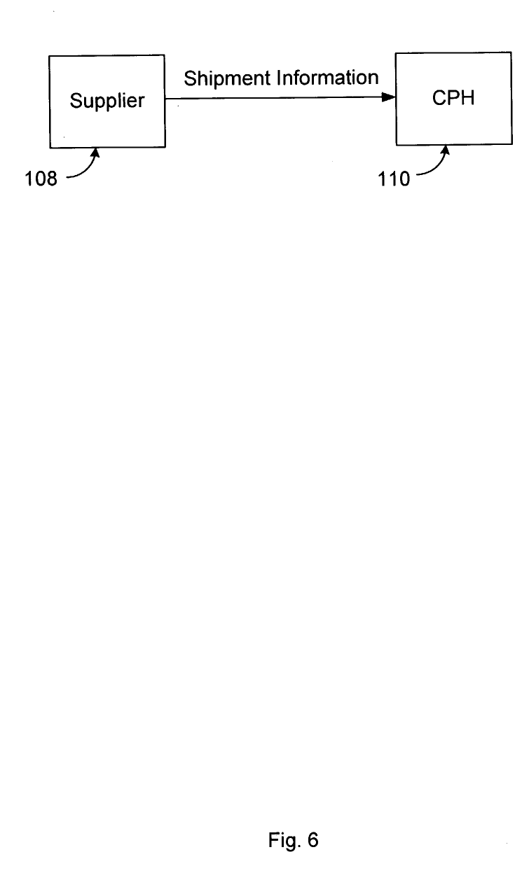

FIG. 18 shows an exemplary scan based magazine trading and information flow system between Supplier 8 and CPH 10. Supplier 8 transmits information to CPH 10 showing detailed shipping information. Typically, this shipping information includes at least one of shipment identification/delivery date, chain ID, store number, UPC code, bipad (a five digit code uniquely identifying the magazine title), title, issue code, cover price and quantity (items not shown).

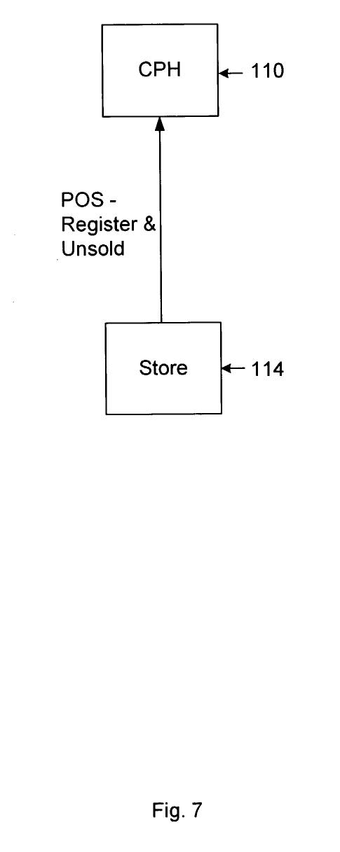

FIG. 20 shows an exemplary scan based magazine trading and information flow system between Store 14 and the CPH 10. In some instances Store 14 can provide point of sale scan data directly to CPH 10 instead of reporting first to Retail Corporate 12. This record includes at least one of transaction date, chain ID, store number, UPC code, issue code (if available), cover price and quantity (not shown).

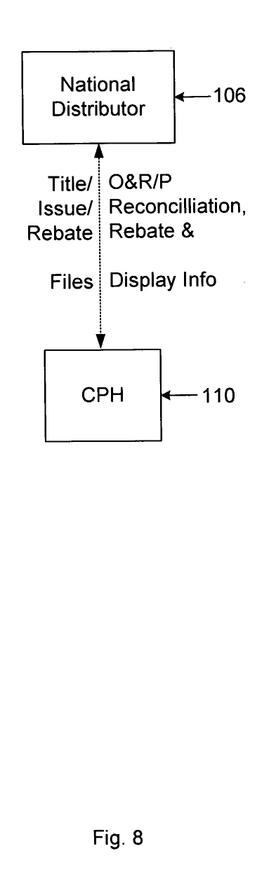

FIG. 22 shows an exemplary scan based magazine trading and information flow system between a National Distributor 6 and the CPH 10. The National Distributor 6 is responsible for providing information on all titles the National Distributor 6 represents. The information needed includes one or more of bipad, title, issue, cover price and rebate information. Data received through other sources could be exchanged between National Distributor 6 and CPH 10 including shipment information, any point of sale scan data, rebate and display information and reconciliation for invoices.

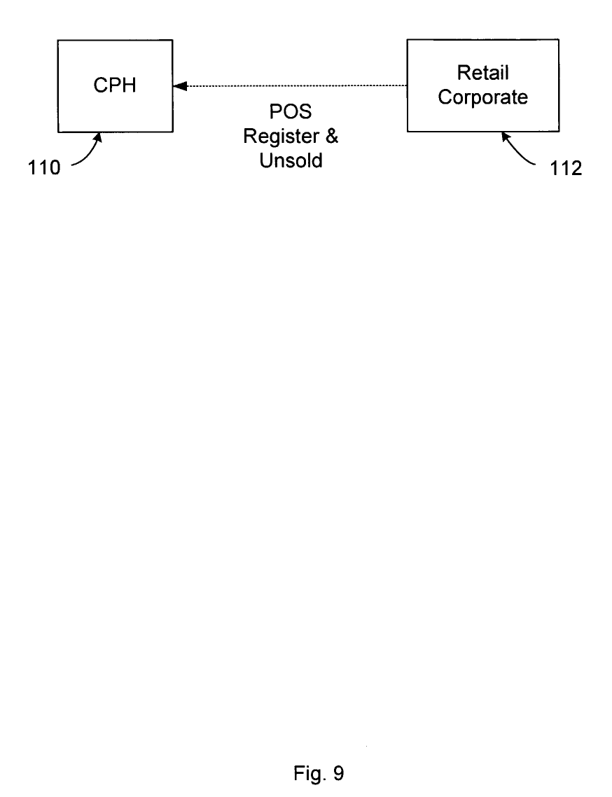

FIG. 24 shows an exemplary scan based magazine trading and information flow system between CPH 10 and Retail Corporate entity 12. Retail Corporate entity 12 can supply point of sale scan data for each magazine sold in all stores within Retail Corporate entity 12 to CPH 10. Retail Corporate entity 12 can communicate to CPH 10 through electronic means to receive UPC updates for the magazines sold in its stores. In some cases, shipment information is obtained from Retail Corporate 12 for CPH 10. (Central Processing Hub/Central Clearinghouse)

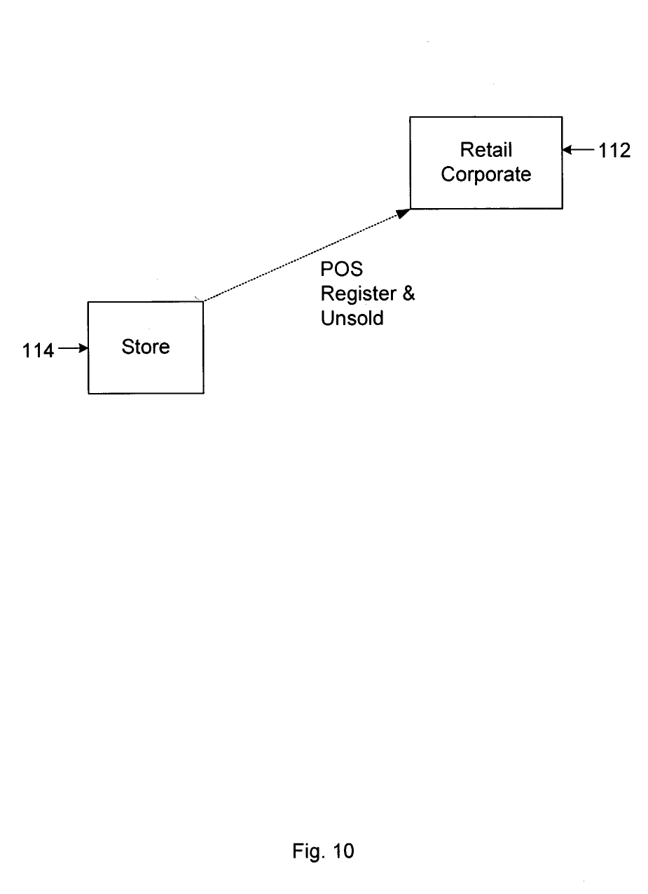

FIG. 26 shows an exemplary scan based magazine trading and information flow system between the Retail Corporate 12 and Store 14. Illustratively, Retail Corporate 12 can retrieve any point of sales scan data from each Store 14 within Retail Corporate group 12. Retail Corporate 12 can download UPC updates received from CPH 10 to each of Stores 14 to ensure accurate collection of magazine sales data.

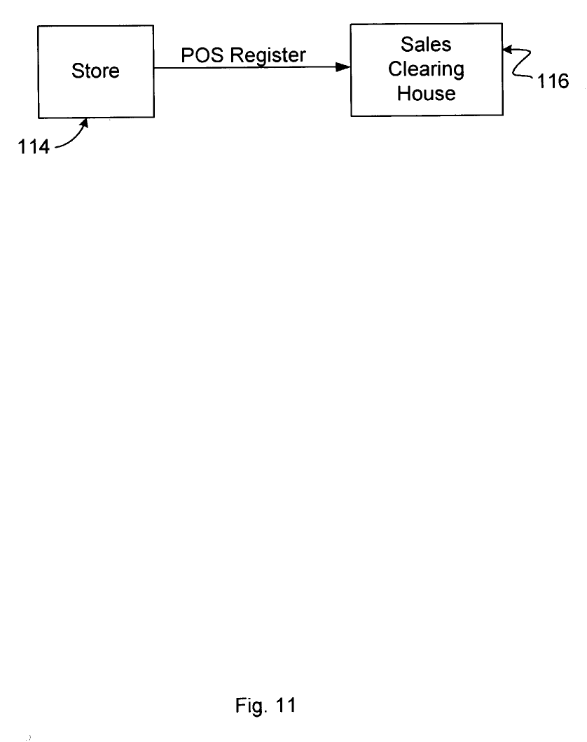

FIG. 30 shows an exemplary scan based magazine trading and information flow system between Store 14 and Sales Clearing House 16. In some cases, Retail Corporate 12 elects to use a Sales Clearing House 16 to collect large amounts of point of sale scan data from each of its Stores 14. In an aspect, Sales Clearing House 16 compiles and platforms all the sales data for the Retail Corporate 12. As used herein, platforms means stores the data and makes it accessible to other entities.

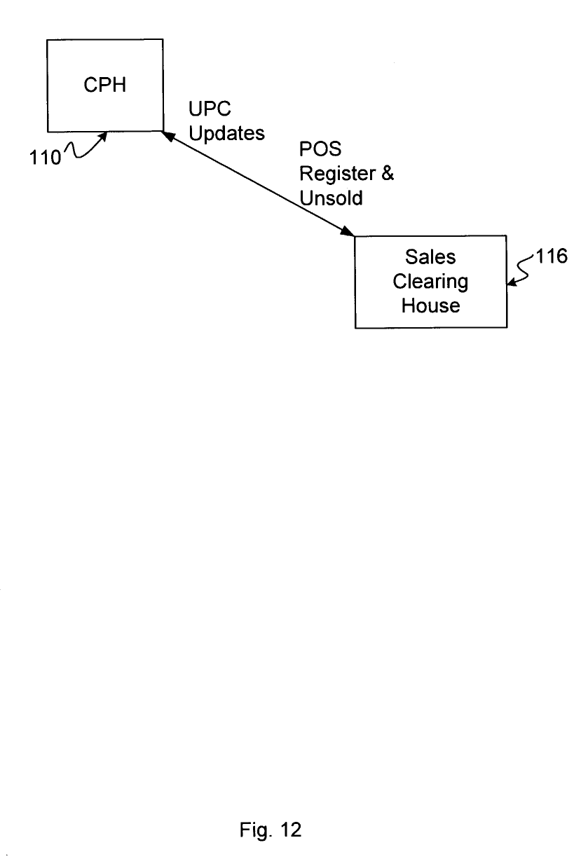

FIG. 32 shows an exemplary scan based magazine trading and information flow system between the Sales Clearing House 16 and CPH 10. In the instances where the point of sale scan data resides at Sales Clearing House 16, the data comes to CPH 10 from Sales Clearing House 16 instead of from Retail Corporate 12 or direct for Store 14. Sales Clearing House 16 may also receive UPC updates from the CPH 10 for pulling sales data based on the active UPC codes for magazines.

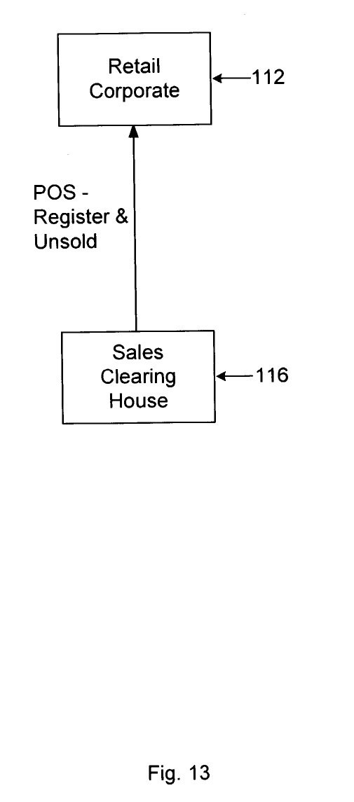

FIG. 34 shows an exemplary scan based magazine trading and information flow system between Sales Clearing House 16 and Retail Corporate 12. Once Sales Clearing House 16 has data from Stores 14, Retail Corporate 12 can access the data from Sales Clearing House 16.

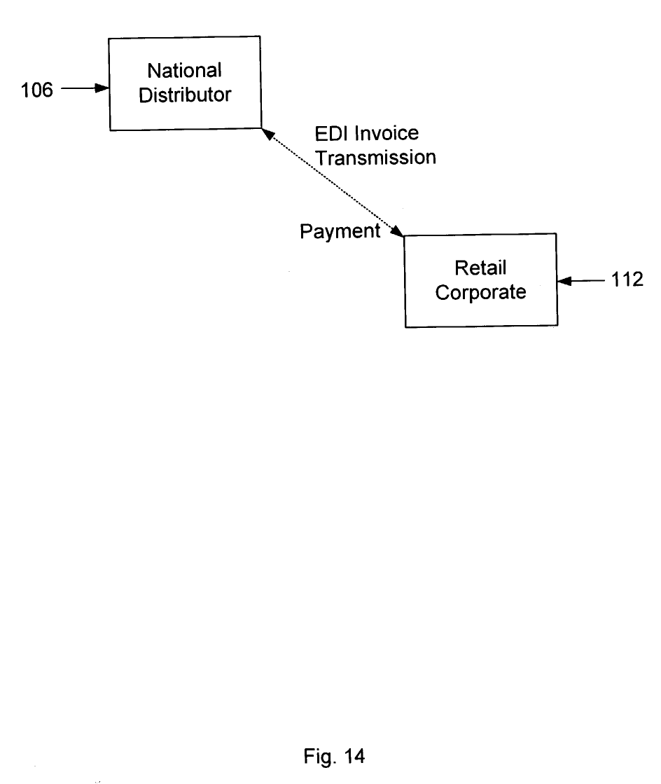

FIG. 36 shows an exemplary scan based magazine trading and information flow system between National Distributor 6 and Retail Corporate 12. In some instances, magazine shipment information will be received from Retail Corporate 12. This data transfer will go through National Distributor 6 and then to CPH 10 for processing.

In an aspect of the invention, a scan based trading system has the capability of collecting accurate information at an appropriate level of detail through an entity such as a company acting as a Centralized Processing Hub (CPH) From an organizational viewpoint, it is important that the CPH (central clearinghouse) remain outside of the distribution chain as a CPH will process information relating to competing publishers and national distributors, retailers, distributors and suppliers. As used herein, scan based trading includes trading such as buying and selling magazines wherein the price of the magazine is made available from and utilized at the store's or retailers scan system and is linked to a UCP code. In an embodiment, the retailer's payment is based on the UPC code.

In an embodiment, a scan based magazine trading process begins with the shipment or delivery of a magazine(s) from a supplier to a retail store. If desired, each day the supplier provides the CPH with shipment quantities identifying how many copies of a magazine were shipped to each individual store, along with the date (or anticipated date) of arrival (called the inbound record). A magazine is identified by a unique UPC code and bipad linked/attached to an issue code. Traditionally, the shipment and delivery triggers a billing event by the supplier to the retailer. In this embodiment, weekly billing will be triggered by receipt of daily scan information received from the retailer to the CPH.

At the retailer level in selling a magazine to a consumer, typically a sales clerk passes the magazine through a scanner to scan a Universal Price Code (UPC) or other bar code on a magazine which results in a Point-Of-Sale (POS) system determination of the price of the magazine based on an electronic data message. The data message (retrieved from a database in the store's computer) translates the bar code read by the scanner into a number unique to that magazine and correlates the number to a price stored in records in the database in the store's POS system. A UPC code is obtained by a magazine publisher and assigned to an issue generally when there is a price change in an issue of that magazine.

The primary objective of receiving shipment and delivery information from a supplier is to enable the CPH to determine the draw and to synchronize the issue, as most retailers lack the ability to read the two digit add-on code identifying the issue. Issue specificity and efficiency are not necessary to calculate invoicing, or even rebates, however publishers still require this information for advertisers and future allotment purposes.

For example, illustratively, if the CPH 10 is notified that thirty copies of UPC code 070989102279, bipad 10227, issue 01 was received at Retailer A's store 14 illustratively on December 28 for example, all scanned activity beginning December 29 for example from store 14 will be interpreted as issue 01. Within the identified retail corporate group, the individual stores' scan data will be aggregated for billing, which can be forwarded to the retailer corporate group each week via EDI, or some other agreed upon method, directly from either the National Distributor 6 or the CPH 10 (depending upon the preference of the national distributor). In a separate transaction scan data will be synchronized with the inbound record to deduce issue specificity and draw, and therefore efficiency.

Currently returns are counted and credited by supplier 8 at their facility. In some instances, returned magazine covers must be collected by the retailer at store 14 and shipped to an independent processing center.

Advantageously, in an embodiment, the shrink is carried by a publisher who absorbs the shrink. As used herein, the term “shrink” means copies of a magazine not accounted for during the sales in a scan based process. These copies are not paid for by the retailer in an embodiment. The magnitude of shrink is variable and will likely change over time and likely change from trading partner to trading partner. Determination of shrink may be determined at agreed upon times at agreed upon frequencies between trading partners. Such determination can be facilitated by a clearinghouse if desired for example.

In an embodiment of the invention, retailers pay only for magazines that scan through a scanner register. Practice of this aspect of the invention will transfer costs to the publisher for any magazine that is stolen and for any magazine that is sold but not properly scanned.

It is desirable to determine who should ultimately bare the cost of the shrink. An initial step in making that determination is to determine the numerical value of the shrink, meaning the difference between what is scanned through the retailer's register, and what is calculated through the traditional method of determining magazines sold, i.e. draw less physical returns. In doing this, the daily scan data will be combined with the inbound records, as well as the processed returns.

Initially, procedures must be implemented by a retailer to retrieve updated UPC code information generally from a central clearinghouse facility.

As part of this initial procedure, this UPC code information is maintained at the retailer's corporate database level and downloaded from some central clearinghouse facility to individual stores so that all magazines will scan at the proper retail price. It is desired to have this updating done in timely periodic fashion. The UPC code is typically changed by the publisher when the issue price of the magazine is changed. In an aspect, the retailer corporate communicates electronically or otherwise with the store.

Updated UPC code information may be obtained in a variety of ways, one of which includes accessing and downloading UPC code information from an interactive customer network having a database with such retail price data. An interactive customer network can be employed to provide the UPC code information.

One particularly useful commercial fee based interactive customer network offering updated UPC code information is available to paid subscribers. (www.sorc-info.com—Source Information Management, 711 Gallimore Dairy Road, High Point, N.C. 27265 USA Telephone: 1-800-966-7661).

A particularly useful exemplary interactive customer network system includes one such as the immediately aforedescribed network system, having at least one database stored on a central server which contains product information and individual remote user profiles, or authorized product lists. Information in the database includes product bipads, titles, UPC information, status, new product information, and special offers or promotions. In addition, the database contains, for specific types of remote users, a unique authorized list for each remote user. The authorized list includes those individual titles that the remote user has selected to stock. Other types of remote users may provide information to be included in the databases.

Such a useful interactive communication network system provides a system for exchanging product information between a plurality of remote users using a distributed computer network. The remote users, for example, may be retailers, publishers, national distributors, local distributors, local suppliers, and consumers. The product information may include, for example, prices, UPC codes, availability of products, distributors for the products, and an authorized list of products for a specific remote user. The term Web as used herein refers to the distributed computer network also known as the World Wide Web. The term page as used herein refers to a document composed in Hyper-text Mark-up Language (HTML) which communicates information over the Web or other network from a computer server at the central site to a remote computer terminal used by the customer. Although the exemplary system described herein is implemented on the Web, it should be understood that the present invention may be implemented on many other distributed computer networks.

A useful exemplary system employs a distributed computer network such as the World Wide Web, referred to herein as the Web. The central server provides a Web site from which information is communicated on pages to the remote computer terminal used by the remote users. At the remote computer terminal, the remote user initially accesses a Web site by typing a specified uniform resource locator (URL) into a Web-browser installed on the remote computer terminal. Once the first page of the Web site has been accessed, additional pages may be viewed by clicking on hyperlinks contained in the pages.

In one embodiment of such a useful interactive customer network system, the location of a page on the Web is specified by a uniform resource locator (URL), which is an alphanumeric string representing the server address on the Web. At the remote computer terminal, the retailer initially accesses a page by typing a specified URL into a Web-browser such as Netscape™ by Netscape Communications Corporation, or Internet Explorer™ by Microsoft Corporation. Multiple pages at a Web site are linked together via hyperlinks which are represented on a computer screen by a graphical icon such as a button or a highlighted line of text. Hyperlinks are configured to implicitly invoke another URL when a computer user clicks on a computer mouse button while a mouse-controlled screen cursor is positioned over a hyperlink icon. In one embodiment, the system is used by a remote user, for example, a retailer which sells magazines to select an authorized list of magazines to be stocked, obtain prices for these products, and communicate with publishers and distributors.

Shrink can be determined using updated UPC data. In an aspect, a method of determining shrink utilizes the delivery date of the magazine to the retailer to determine the issue of the POS data and to link a sale number to the inbound (supplied) magazine copies. For example, using this method generates an illustrative analysis shown in Table 1 data following.

TABLE 1

| | Thursday | Friday | Saturday | Sunday | Monday | Tuesday | Wednesday | Thursday | |
|---|---|---|---|---|---|---|---|---|---|
| | 28 | 29 | 30 | 31 | 1 | 2 | 3 | 4 | TOTALS |
| Supplier | 40 | | | | | | | | 40 |
| Retailer- | | −8 | −7 | −5 | −3 | −3 | −1 | 0 | −27 |
| POS | | | | | | | | | |
| Retailer- | | | | | | | | −12 | −12 |
| Return | | | | | | | | | |
| Reconcilia- | | | | | | | | | 1 |
| tion- | | | | | | | | | |
| Shrink | | | | | | | | | |

In Table 1, data for the initial shipment quantity (draw) shown for supplier, the activity scanned at the register shown as retailer-POS, and the retailer returns scanned out of the store can be combined at the CPH 10 to provide a full reconciliation-shrink, between the scan data and the ‘Order and Regulation” information. This method is referred to herein as a transaction date method. As used herein, (O & R) is a term identifying the number of copies of each magazine that was sent into each store. In this illustrative data, the reconciliation-shrink numerically is one magazine. Since forty magazines were shown illustratively as being supplied on the 28^{th} for example, an assumption is made that the next day and following days retailer POS is linked to that previous day's supply. This method assumes that the retailer receives supplied magazines and stocks store shelves with the magazines and that next and thereafter day sales are from that supply. It is understood that there can be left over magazines on the retailers shelf which can get linked to a new supply. However such instances are likely small in number and the number of magazines is likely to be small in comparison to the number supplied.

In assembling shrink data, an illustrative activity record can be complied having fields as shown in Table 2:

TABLE 2

| Chain: | A |
|---|---|
| Store: | 10 |
| UPC: | 070989102279 |
| Bipad: | 10227 |
| Issue: | 01 |
| Draw: | 40 |
| Scanned: | 27 |
| Return: | 12 |
| O/R Net: | 28 |
| Differential: | 1 |

This information can be combined with the following Title File record at the CPH:

Bipad

Title

Publisher

National Distributor

Discount

Compliance Threshold

The title File can be linked to an Issue File (also at the CPH) containing the following data:

Issue #

On Sale

Off Sale

UPC Code(s)

Cover Price(s)

Another particularly preferred and useful method to determine shrink involves publishers/national distributors assigning multiple UPC codes to each price point for each magazine.

For example, a magazine published on a weekly basis would need at least three separate UPC codes for each price point. A magazine published monthly would need at least two separate UPC codes for each price point.

Using this method, the publisher/national distributor can “Flip Flop” (i.e. change) the UPC codes on the magazines, which would provide a record that the magazine issue had changed even if the magazine price remained the same. (Normally the UPC code is changed only when the issue price is changed.) This is done when the time is relatively short between the days when different issues could be placed for sale on stands and there could be significant residual magazines unsold out of issue date magazines on the stands. This is not necessarily undesirable because sometimes consumers wish to purchase a previous or older issue.

In this aspect, the publisher changes UPC codes so that the publisher timely links sales volume with cover design of each issue. With this information, even if there are magazines from one or more issues having the same price, the POS sales activity could more easily and accurately be aligned/linked with the inbound copies received at the stores from the supplier. Thus the publisher can timely link sales volume to issue cover design. The time interval between changes in the UPC Code in this aspect will vary and may be determined according to the magazine, trading partners, marketing situation and other factors. The time interval can be days or weeks for example. The time interval between a first and second UPC Code change can the same or different as the time interval between a second and third UPC Code change. In an aspect, a first UPC Code can be assigned for days or a week to a first issue, and then a second different UPC Code can be assigned to a second issue. In this instance the cover price may remain the same. After another week or so, the publisher may change or revert the second UPC Code back to the first UPC Code even for a different issue with the same price, in that the publisher can determine that sufficient time has passed so that the publisher can timely link sales volume of each issue to respective issue cover design. In this aspect different covers are generally employed on successive different issues of a magazine.

Alternatively, in an embodiment, the retailer could upgrade their system to pick up (scan) the additional two digit add on code or the publisher could assign a unique UPC code for each issue during a year.

In this aspect date can be obtained for a store which can be identified by number. Date can include issue identification, transaction date, bipad identification, draw number, returned number, issue year, sale date, price, UPC code, total sales and issue.

The magazines illustratively listed can bear a first UPC code between an 11^{th} day of a month and an 18^{th} day of a month for example, would be for an issue based on the sales within that seven day period of time. Illustrative sales picked up under a second illustrative UPC code would be contributed to a second illustrative issue. There can be illustrative sales shown under both IPC codes on an 18^{th} day of a month. We can attribute the sale to the appropriate issue using the flip flop method in this instance. Looking at the sales overlap between a 21^{st} day and a 23^{rd} day it can be seen that the initial UPC code picked up sales activity again. Without a second UPC Code, this could be confused with the first illustrative issue, when it should be attributed to another issue. If there were a third UPC code used with the original and remaining sales point, the sales activity could be more clearly attached/linked to the correct issue.

Cumulatively, this data can enable the centralized processing hub to calculate, forward and reconcile the information necessary for the National Distributor to produce invoices. National Distributors can also use this same information to set allotments for future issues. The retailer bases payments on the scan based sale data. The scan data is the invoice here.

After shrink is identified and quantified and agreed upon by distributor and retailed, the shrink value can be worked into a discount structure to the retailer which is acceptable to distributor and retailer. Utilizing shrink in this way and allowing the retailer to issue payments eliminates returns. Retailers can dispose of unsold magazine copies at the retailer store and returns are optional or are eliminated.

A new data record can resemble the following data illustrated in Table 3 following.

TABLE 3

| | Thursday | Friday | Saturday | Sunday | Monday | Tuesday | Wednesday | Thursday | |
|---|---|---|---|---|---|---|---|---|---|
| | 28 | 29 | 30 | 31 | 1 | 2 | 3 | 4 | TOTALS |
| Supplier | 40 | | | | | | | | 40 |
| Retailer- | | −8 | −7 | −5 | −3 | −3 | −1 | 0 | −27 |
| POS | | | | | | | | | |
| Efficiency | | | | | | | | | 67.50% |

Rebates are used by distributors to enhance sales of magazines. They are utilized to encourage a positive purchase decision. The amount of a rebate is set by the distributor.

A rebate can be applied to the retailer scan based sales record and the effect of the rebate calculated through the use of the same non-issue specific scan data used to invoice the retailer. Advantageously, this rebate can be calculated at the store level. The calculation of rebate at retailer store level presents both a retailer and a publisher with unique opportunities.

For example, a publisher could establish a rebate of 0% of a magazine cover price for the first 5 magazines sold per issue at a store, 5% for the next 10 magazines and 10% for the next 10 magazines. The publisher would have the ability to fill out the following type of Table 4 following creating an automatic rebate.

TABLE 4
Rebate Illustration

| Magazines/ | |
|---|---|
| Issue/ | |
| Store | % Rebate of Cover Price |
| 0-5 | 0% of Cover |
| 6-10 | 5% of Cover |
| 11-20 | 7.5% of Cover |
| 21-50 | 10% of Cover |
| 50+ | 15% of Cover |

The rebate process can be automated as shown above. As illustrated in the table above, national distributors are provided with an opportunity to create an additional incentive for retailers with a rebate to maximize the accuracy of the retailer scan based sales system. Rather than basing the rebate on the calculated net (draw less returns) as done in the past, in an embodiment, the rebate can now be based exclusively on POS activity through the scan based checkout retailer register.

Illustratively, using this method, for example, if there were a magazine draw of twenty, a POS sale of five magazines and a return from the retailer to the distributor of five magazines, the retailer would receive a rebate based on five magazines sold. This type of rebate creates an incentive for a store to provide an accurate scan based sales record, for store personnel to scan magazines (as opposed to keying in the price with no UPC code which does not result in a sale being recorded in the scan based record for that magazine), and to correct the scan based retailer record if necessary.

Publishers sometimes pay retailers to rent space on a rack (or a pocket which accommodates magazines) near the checkout line as this rental enhances magazine sales. The rate paid for a retail display pocket (RDP) for a magazine is an important aspect of scan based magazine trading. RDP generally is a flat rate paid by the distributor to the retailer for renting such space on a retailer's magazine rack (or pocket). In another aspect of this invention, a publisher can set up payment criteria for paying the retailer, such as magazines per pocket which has units of magazines displayed or housed per pocket.

Table 5 illustrates the creation of a units per pocket payment criteria for a magazine.

TABLE 5

| Average Magazines | |
|---|---|
| per Pocket per Store | RDP Rate ($/pocket) |
| <3 | $2 |
| 4-6 | $5 |
| 7-10 | $7 |
| 11-20 | $10 |
| 20+ | $12.50 |

In Table 5, illustratively for a weekly magazine, the RDP rate would be divided by 13 weeks in a quarter and for a monthly magazine issue the RDP rate would be divided by three months in a quarter.

The RDP rate can be applied to the retailer scan based payment record in a manner agreed to by the distributor and the retailer. As shown in the table above, the RDP $ rate per pocket would increase based on an increased sales for that pocket. Thus the RDP can be factored and incorporated into the retailer scan based payment record and a separate RDP payment processing function can be minimized or avoided.

Advantageously, by retailers making payments to publishers based on scan based sales records accelerates cash flow to the distributors since retailers generally pay suppliers within 30 days. Having the retailer pay the national distributor results in advantageous 30-day invoice payment terms to the National Distributor.

In a payment aspect, while the clearinghouse could receive payment, it is likely that the payment will be transmitted directly from the retailer to the national distributor. In another aspect, the clearinghouse can compile the information for an invoice which can then be forwarded to a national distributor for invoicing to retail corporate. Retail corporate can then send payment directly to the national distributor.

In another payment aspect, the publisher is paid from a national distributor, if there is a national distributor although some publishers may elect to handle their own billing and collection.

From the preceding description of various embodiments of the present invention, it is evident that the objects of the invention are attained. Although the invention has been described and illustrated in detail, it is to be clearly understood that the same is intended by way of illustration and example only and is not to be taken by way of limitation.

What is claimed is:

1. scan based magazine trading system, said system comprising;
(a) a distributor and
(b) a retailer
whereby the distributor provides the retailer with at least one bar coded magazine and wherein the retailer sells the magazine utilizing a scan based sale thereby generating a scan based trading retailer payment record.

2. A scan based trading system in accordance with claim 1 comprising designating the scan based trading payment record for the distributor and the distributor is a national distributor.

3. A scan based trading system in accordance with claim 1 comprising converting the record to a payment.

4. A scan based trading system in accordance with claim 1 comprising determining a shrink factor to be applied to the scan based trading payment record.

5. A scan based trading system in accordance with claim 3 comprising determining and arriving at a shrink factor by comparing the transaction date method with the flip flop method.

6. A scan based trading system in accordance with claim 1 comprising determining the shrink factor by obtaining the agreement of two parties to a magazine trading transaction.

7. A scan based trading system in accordance with claim 4 comprising presenting the shrink factor to the distributor and retailer, obtaining agreement of the distributor and retailer that the shrink factor is to be applied to the scan based trading payment record.

8. A scan based trading system in accordance with claim 5 comprising the shrink factor to the distributor and retailer and obtaining agreement of the distributor and retailer that the shrink factor is to be applied to the scan based trading payment record.

9. A scan based trading system in accordance with claim 6 comprising obtaining agreement of the distributor and retailer that the retailer determines the amount of payment to the distributor based on the scan based trading payment record.

10. A scan based trading system in accordance with claim 5 wherein the shrink factor is presented to the distributor and retailer and the retailer applies the shrink factor to the scan based trading payment information.

11. A scan based trading system in accordance with claim 8 comprising applying the shrink factor to the scan based trading payment information and generating scan based trading payment information acceptable to the distributor.

12. A scan based trading system in accordance with claim 8 comprising providing a transfer payment to the distributor based on the scan based trading payment record.

13. A scan based trading system in accordance with claim 5 comprising applying a distributor generated rebate to the scan based trading information.

14. A scan based trading system in accordance with claim 6 comprising applying a distributor generated rebate to the scan based trading information.

15. A scan based trading system in accordance with claim 10 comprising paying the distributor based on scan based trading information.

16. A computer network-based system for electronically exchanging scan based magazine trading data between a central site and a plurality of remote users, said system comprising:
a central server;
at least one database installed on said server, said database comprising data representing information related to retailer payment of at least one scan based magazine trade, said database comprising at least one of a product price, a UPC code, a bipad number, a goods availability, an issue and a product distributor; and
at least one remote computer terminal having an input device for generating input data, and an output device, said remote terminal connected to said central server for transmitting data between said central server and said remote terminal.

17. A system in accordance with claim 16 wherein the data comprises a shrink factor and a sales volume.

18. A system in accordance with claim 11 wherein the remote terminal and central server are coupled together electronically.

19. A system in accordance with claim 12 wherein the remote terminal and server are coupled by a communications hyperlink for exchanging data between said central server and the remote user.

20. A system in accordance with claim 12 wherein the remote terminal is operated by a retailer.

21. A scan based magazine trading system said system comprising;
(a) a distributor
(b) a retailer
(c) a clearinghouse wherein the clearinghouse facilitates the flow of trading information between the distributor and retailer and the retailer pays the distributor.

22. A scan based magazine trading system in accordance with claim 21, wherein
(a) the distributor provides the retailer with at least one bar coded magazine and provides a record thereof to the clearinghouse,
(b) the retailer sells the magazine utilizing a scan based sale generating data and provides a record thereof to the clearinghouse and
(c) clearinghouse stores distributor and retailer records and accepts payment from the retailer on behalf of the distributor for the retail scan based sale.

23. A scan based magazine trading system in accordance with claim 21, wherein the clearinghouse performs at least one of reconciling any discrepancies in the data of distributor and retailer, determines a shrink factor for a retailer and distribution trading combination, applies a shrink factor to the retailer data and facilitates payment to distributor through communication with retailer and distributor.
